(19) United States
(12) Patent Application Publication
(10) Pub. No.: US 2026/0225696 A1
(43) Pub. Date: Aug. 6, 2026

(54) ADAPTIVE SHIP SPEED CONTROL METHOD AND DEVICE

(71) Applicant: AVIKUS CO., LTD., Seoul (KR)

(72) Inventors: Doyeon JUNG, Seoul (KR); Hujae CHOI, Seoul (KR); Jinmo PARK, Seoul (KR); Kwangsung KO, Seoul (KR)

(21) Appl. No.: 19/513,422

(22) PCT Filed: Mar. 25, 2025
(86) PCT No.: PCT/KR2025/003802

§ 371 Date: Feb. 23, 2026

(30) Foreign Application Priority Data
Jul. 2, 2024 (KR) 10-2024-0087186
Dec. 19, 2024 (KR) 10-2024-0191389

(51) Int. Cl. B63B 79/40; B63B 49/00; B63B 79/10; G08G 3/02

(52) U.S. Cl. CPC B63B 79/40; B63B 49/00; B63B 79/10; G08G 3/02

(57) ABSTRACT

An embodiment of the present disclosure discloses an adaptive vessel speed control method including: identifying at least one target vessel in front of an own vessel while navigating on a first path; determining a probability of collision with the at least one target vessel identified; when it is determined that there is the probability of collision, controlling the own vessel to perform an avoidance maneuver based on criteria; and after the avoidance maneuver is performed and the probability of collision is resolved, controlling a speed of the own vessel to return to that before identifying the target vessel determined to have the probability of collision.

### TECHNICAL FIELD

The present disclosure relates to a method of controlling speed of a vessel, and more particularly, to a method of adaptively controlling speed of a vessel in an overtaking situation and an apparatus for implementing the method.

### BACKGROUND ART

Due to the development of autonomous driving technology, autonomous driving technology for not only land-based vehicles but also vessels at sea is advancing day by day. The autonomous navigation method of small boats among vessels is basically implemented as a process that follows the path input into the boat, and has the characteristic of not navigating along any other path than the input path.

However, obstacles that are suddenly encountered while the boat is navigating make it difficult for the boat to follow the preset path. Especially in places where there is not enough space to avoid obstacles, such as narrow channels, the boat's avoidance strategy for encountering obstacles is highly important. That is, in order to perform stable path following during the autonomous navigation process of a boat, collision avoidance strategies must be individually established differently depending on the type of obstacle the boat encounters.

Typically, a boat navigating in autonomous mode will maintain a preset path and overtake an obstacle ahead in an overtaking situation. However, if the boat is navigating in a narrow area such as a narrow channel or there are multiple target vessels in front of the boat, it may be a safer choice not to overtake even in a situation where an overtaking situation is identified. In other words, in autonomous navigation, a methodology that is operable in a particular situation is needed.

### DISCLOSURE OF INVENTION

### Technical Problem

The technical problem to be solved by the present disclosure is to provide a method of adaptively controlling speed of a vessel and an apparatus for implementing the method.

### Technical Solution to Problem

A method according to an embodiment of the present disclosure for solving the above technical problem includes: identifying at least one target vessel in front of an own vessel while navigating on a first path; determining a probability of collision with the at least one target vessel identified; when it is determined that there is the probability of collision, controlling the own vessel to perform an avoidance maneuver based on criteria; and after the avoidance maneuver is performed and the probability of collision is resolved, controlling a speed of the own vessel to return to that before identifying the target vessel determined to have the probability of collision.

An apparatus according to another embodiment of the present disclosure for solving the above technical problem includes: a memory storing at least one program; and a processor configured to perform an operation by executing the at least one program, wherein the processor is further configured to identify at least one of target vessels and obstacles in front of an own vessel during navigation on a first path, determine a probability of collision with at least one of the identified target vessels and obstacles, when it is determined that there is the probability of collision, control the own vessel to perform an avoidance maneuver based on criteria, and after the avoidance maneuver is performed and the probability of collision is resolved, control a speed of the own vessel to return to that before identifying a target vessel determined to have the probability of collision.

### Advantageous Effects of Invention

According to the present disclosure, collisions between vessels navigating in narrow channels may be prevented.

### BRIEF DESCRIPTION OF DRAWINGS

FIG. 1 is a flowchart showing an example of a method according to the present disclosure.

FIG. 2 is a block diagram illustrating an example of an adaptive speed control apparatus according to the present disclosure.

FIG. 3 is a diagram for describing a sub-module included in a processor of FIG. 2.

FIG. 4 is an example of a diagram for describing target vessels identified in an overtaking space.

FIG. 5 is another example of a diagram for describing target vessels identified in an overtaking space.

FIG. 6 is a diagram for describing a target vessel having a lowest speed, which is criteria for determining an avoidance maneuver of an own vessel, in the present disclosure.

FIGS. 7 to 12 are diagrams illustrating an adaptive speed control method according to the present disclosure, by using visualized information.

### BEST MODE FOR CARRYING OUT THE INVENTION

A method according to an embodiment of the present disclosure for solving the above technical problem includes: identifying at least one target vessel in front of an own vessel while navigating on a first path; determining a probability of collision with the at least one target vessel identified; when it is determined that there is the probability of collision, controlling the own vessel to perform an avoidance maneuver based on criteria; and after the avoidance maneuver is performed and the probability of collision is resolved, controlling a speed of the own vessel to return to that before identifying the target vessel determined to have the probability of collision.

In the method, the controlling to perform the avoidance maneuver may include controlling the own vessel to perform an avoidance maneuver when, in a state where the probability of collision is determined, the area in which the own vessel is currently navigating is determined to be a narrow channel with a width less than a preset width, based on a sensing value of a sensor of the own vessel.

In the method, the at least one target vessel may be in a preset overtaking section.

In the method, the criteria may include a condition for a lowest speed among speeds of the at least one target vessel.

In the method, the controlling to perform the avoidance maneuver may include detecting a target vessel within a first distance from the own vessel and then searching for a target vessel with a lowest speed among speeds of the at least one target vessel.

In the method, the controlling to perform the avoidance maneuver may include controlling the speed of the own vessel to be reduced to the lowest speed.

In the method, the controlling to perform the avoidance maneuver may include, when the lowest speed among the speeds of the target vessels is faster than a current speed of the own vessel, controlling to maintain the current speed of the own vessel.

In the method, the determining of the probability of collision may include controlling the determined probability of collision to be output as visualized information by using a display device.

In the method, the determining of the probability of collision may include controlling a target vessel with a lowest speed among the identified target vessels to be highlighted and displayed using the display device.

In the method, the determining of the probability of collision may include controlling to output a safety distance in addition to the first path on the display device, and controlling to highlight and display a target vessel that has come into contact with the safety distance among the identified target vessels.

In the method, the determining of the probability of collision may include, when there is a target vessel among the identified target vessels, which has come

Into contact with the safety distance, controlling the first path to be highlighted and displayed.

In the method, the performing of the avoidance maneuver may include, when it is determined that there is the probability of collision and a direction of travel of the target vessel is opposite to a direction of travel of the own vessel, generating a second path in addition to the first path, and displaying the generated second path by using a display device.

In the method, the performing of the avoidance maneuver may include, when it is determined that there is the probability of collision and a direction of travel of the target vessel is opposite to a direction of travel of the own vessel, controlling an auxiliary triangle corresponding to the direction of travel of the target vessel such that the auxiliary triangle is highlighted and displayed on a mini-map displayed on a vessel or a user terminal.

An apparatus according to another embodiment of the present disclosure for solving the above technical problem includes: a memory storing at least one program; and a processor configured to perform an operation by executing the at least one program, wherein the processor is further configured to identify at least one of target vessels and obstacles in front of an own vessel during navigation on a first path, determine a probability of collision with at least one of the identified target vessels and obstacles, when it is determined that there is the probability of collision, control the own vessel to perform an avoidance maneuver based on criteria, and after the avoidance maneuver is performed and the probability of collision is resolved, control a speed of the own vessel to return to that before identifying a target vessel determined to have the probability of collision.

### Mode for Carrying out the Invention

As the present disclosure allows for various changes and numerous embodiments, particular embodiments will be illustrated in the drawings and described in detail in the written description. The effects and features of the present disclosure, and ways to achieve them will become apparent by referring to embodiments that will be described later in detail with reference to the drawings. However, the present disclosure is not limited to the following embodiments but may be embodied in various forms.

Hereinafter, the embodiments of the present disclosure will be described below in more detail with reference to the accompanying drawings. Those components that are the same or are in correspondence are rendered the same reference numeral regardless of the figure number, and redundant explanations are omitted.

It will be understood that although the terms “first”, “second”, etc. may be used herein to describe various components, these components should not be limited by these terms. These terms are only used to distinguish one component from another.

Singular expressions, unless defined otherwise in contexts, include plural expressions.

In the embodiments below, it will be further understood that the terms “comprise” and/or “have” used herein specify the presence of stated features or components, but do not preclude the presence or addition of one or more other features or components.

When an embodiment is implementable in another manner, a predetermined process order may be different from a described one. For example, two processes that are consecutively described may be substantially simultaneously performed or may be performed in an opposite order to the described order.

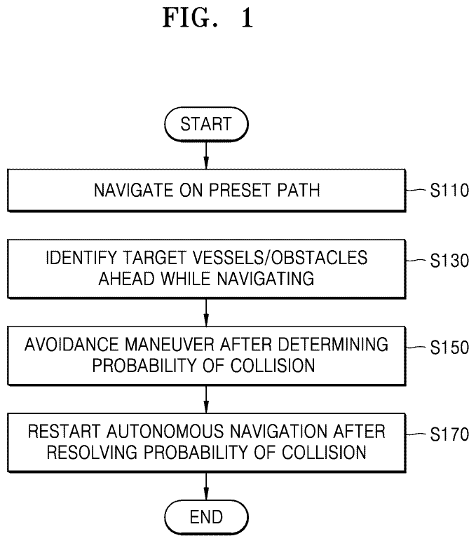

FIG. 1 is a flowchart showing an example of a method according to the present disclosure.

The method according to the present disclosure relates to a method of adaptively controlling speed of a vessel, and presents a methodology for avoiding collisions of vessels in narrow channels. The method according to the present disclosure may be implemented by an adaptive speed control apparatus 200 described below.

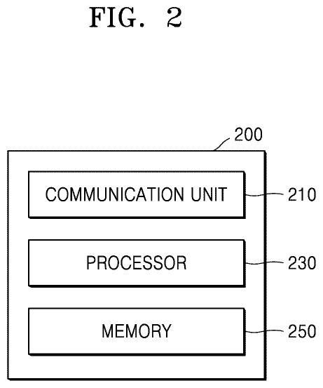

The adaptive speed control apparatus 200 may initiate navigation after a vessel that is autonomously navigating along a preset path (S110) identifies a target vessel or obstacles ahead while navigating (S130). The adaptive speed control apparatus 200 may determine a probability of collision with a target vessel or an obstacle, and when it is determined that there is a probability of collision, control the vessel to perform an avoiding maneuver according to a predetermined procedure (S150). When the probability of collision with the target vessel or the obstacle ahead is resolved, the adaptive speed control apparatus 200 may control the speed of the vessel to return to the speed before identifying the target vessel ahead. Operations S130 to S170 will be described in detail with reference to FIGS. 2 to 12.

FIG. 2 is a block diagram illustrating an example of an adaptive speed control apparatus according to the present disclosure.

The adaptive speed control apparatus 200 according to the present disclosure is considered to be an apparatus connected to a main controller that controls a vessel in a wired or wireless manner and controls acceleration/deceleration of the vessel. Thus, the adaptive speed control apparatus 200 may be physically or logically included in a control panel of the vessel, implemented in the form of hardware physically separated from the vessel, or implemented in the form of an application installed on a user terminal used by a user. Hereinafter, an own vessel is considered to be a vessel on which a user is riding or the speed of which is controlled by the adaptive speed control apparatus 200, and target vessels are considered to be vessels other than the own vessel.

Referring to FIG. 2, it may be seen that the adaptive speed control apparatus 200 includes a communication unit 210, a processor 230, and a memory 250.

The communication unit 210 may include one or more components that allow wired/wireless communication with an external device. For example, the communication unit 210 may include at least one piece of hardware necessary to implement short-range communication such as Wifi or Bluetooth in a network provided by a communication network, or to implement various communications including the Internet when a LAN cable is connected thereto.

The memory 250 may be hardware that stores various data processed within the adaptive speed control apparatus 200, and store a program for processing and controlling the processor 230. The memory 250 may include random access memory (RAM) such as dynamic random access memory (DRAM), static random access memory (SRAM), read-only memory (ROM), electrically erasable programmable read-only memory (EEPROM), CD-ROM, Blu-ray or other optical disk storage, hard disk drive (HDD), solid state drive (SSD), or flash memory.

The processor 230 may control the overall operation of the adaptive speed control apparatus 200. For example, the processor 230 may control the operation of an input unit (not shown), a display (not shown), the communication unit 210, the memory 250, etc. included in the adaptive speed control apparatus 200 by executing programs stored in the memory 250.

As an example, the processor 230 may determine a probability of collision with at least one of identified target vessels and obstacles, and when it is determined that there is the probability of collision, control the own vessel to perform an avoidance maneuver based on criteria, and when the probability of collision is resolved after the avoidance maneuver, control the own vessel to return to that before identifying the target vessel that was determined to have the probability of collision.

When the adaptive speed control apparatus 200 is implemented as a physical device, the processor 230 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

In addition, when the adaptive speed control apparatus 200 of the present disclosure is implemented in the form of an application (program) that runs on an integrated data processing device such as a server, the processor 230 and the memory 250 included in the adaptive speed control apparatus 200 may be implemented in the form of a virtual machine that implements hardware such as DSPs, microcontrollers, RAM, ROM, HDD, etc. as software (command script).

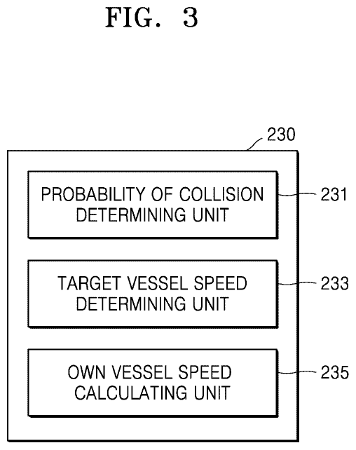

FIG. 3 is a diagram for describing a sub-module included in a processor of FIG. 2.

Referring to FIG. 3, it may be seen that the processor 230 includes a probability of collision determining unit 231, a target vessel speed determining unit 233, and an own vessel speed calculating unit 235. The probability of collision determining unit 231, the target vessel speed determining unit 233, and the own vessel speed calculating unit 235 illustrated in FIG. 3 are modules that are logically and conceptually separated to explain a process performed by the processor 230 in the process of implementing the vessel speed control method according to the present disclosure, and thus, although three sub-modules are illustrated in FIG. 3, the processor 230 may include fewer than three or more than three sub-modules according to an embodiment. In addition, the probability of collision determining unit 231, the target vessel speed determining unit 233, and the own vessel speed calculating unit 235 of FIG. 3 are sub-modules of the processor 230, and thus, in the same manner as the processor 230, may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

The probability of collision determining unit 231 may determine a probability of collision with at least one of the identified target vessels when at least one target vessel is identified while the vessel is navigating on a first path. First, when at least one target vessel in front of the own vessel is detected by a sensor (camera, distance sensor, speed detection sensor, LIDAR, etc.) installed on the own vessel while the own vessel is navigating along the preset first path, the probability of collision determining unit 231 may determine a probability of collision with the detected target vessel. When a plurality of target vessels are identified, the probability of collision determining unit 231 may determine a probability of collision with all of the plurality of target vessels.

As an embodiment, the probability of collision determining unit 231 may determine the probability of collision with an identified target vessel, when the area in which the own vessel is currently navigating is determined to be a narrow channel with a width less than a preset width, based on a sensing value of a sensor of the vessel. The present disclosure is designed to suggest an avoidance maneuver method for a small vessel such as a vessel in an area where there is not enough avoidance space, such as a narrow channel, and thus, when the area where the vessel is currently navigating is not a narrow channel but an area where avoidance space is open in various directions, the probability of collision determining unit 231 may implement an avoidance maneuver based on an avoidance process different from the avoidance maneuver according to the present disclosure.

In the present disclosure, a target vessel identified by the own vessel while navigating on the first path may be in a preset overtaking space. That is, when the target vessel is in the overtaking space, the probability of collision determining unit 231 may determine that the target vessel has a probability of collision with the own vessel. Here, the overtaking space refers to the space located at a relative distance and direction of movement that allows the own vessel to overtake the target vessel ahead through acceleration and alter course. Typically, the area of the overtaking space may be expanded in proportion to the performance of the sensors installed on the own vessel, but is not limited thereto.

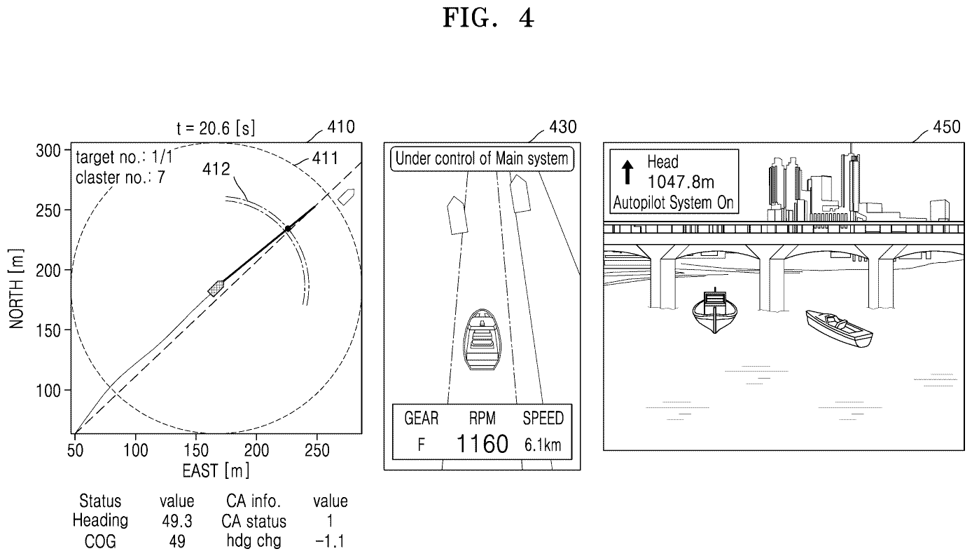

FIG. 4 is an example of a diagram for describing target vessels identified in an overtaking space.

In detail, FIG. 4 is a diagram exemplifying vessel navigation control information that may be output through a display device installed on a control panel of an own vessel or a screen of a smart terminal used by a user. The navigation control information illustrated in FIG. 4 may include at least one of a first screen 410, a second screen 430, and a third screen 450.

The first screen 410 of FIG. 4 shows a maritime mini-map. The first screen 410 of FIG. 4 shows the relative distance between the own vessel and a target vessel, and in particular, an overtaking space 411 and a safety distance 412 of the own vessel are shown. In the first screen 410 of FIG. 4, the overtaking space 411 has a circular shape, and when the target vessel is located within the overtaking space 411, the probability of collision determining unit 231 may determine that there is a probability of collision between the own vessel and the target vessel. Referring to the first screen 410 of FIG. 4, as there is no target vessel in the overtaking space, the probability of collision determining unit 231 may determine that there is no target vessel with a probability of collision. In addition to the maritime mini-map, the first screen 410 of FIG. 4 may display motion parameters such as the vessel's heading, COG (Course Over Ground), CA status, and hdg chg (heading change), and the user may utilize the displayed motion parameters to control the own vessel.

The second screen 430 of FIG. 4 shows an example of maritime navigation. In detail, the second screen 430 of FIG. 4 displays the gear status, engine RPM, and speed of the own vessel, and a path that the own vessel is following and the identified target vessels located in front of the own vessel may be displayed in the form of icons.

The third screen 450 of FIG. 4 illustrates an example of a front image of the own vessel collected from a camera mounted on the bow of the own vessel. The third screen 450 of FIG. 4 shows a bridge and two target vessels in front of the own vessel. A user may approximately determine the appearance of the bridge and the target vessels located in front of the own vessel through the third screen 450.

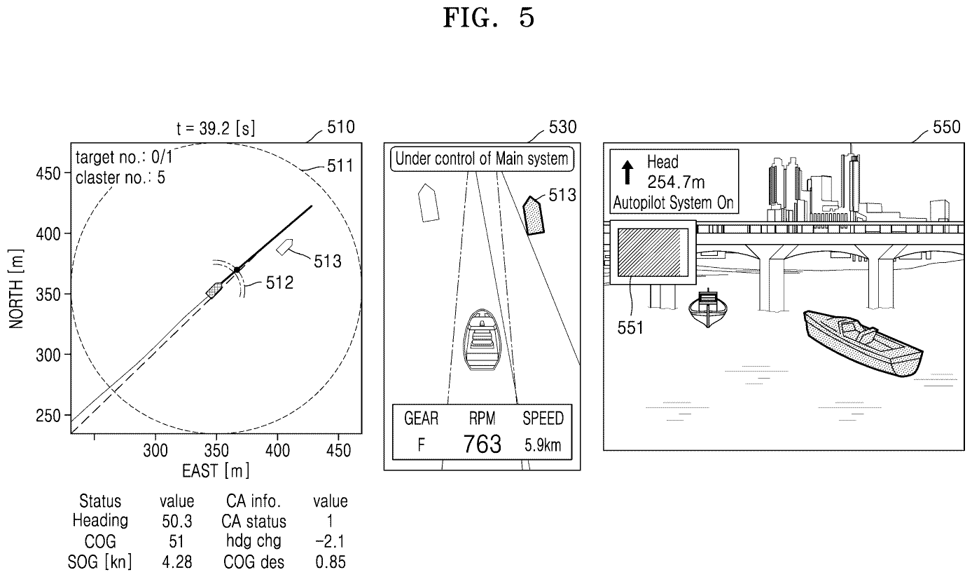

FIG. 5 is another example of a diagram for describing target vessels identified in an overtaking space.

The navigation control information illustrated in FIG. 5 may include at least one of a fourth screen 510, a fifth screen 530, and a sixth screen 550.

The fourth screen 510 of FIG. 5, as the first screen 410 of FIG. 4, shows a maritime mini-map. In particular, the fourth screen 510 of FIG. 5 shows an overtaking space 511 and a safety distance 512 of the own vessel. As one target vessel 513 is located within the overtaking space 511 of the own vessel, the probability of collision determining unit 231 may determine that there are target vessels identified and that there is a probability of collision with the identified target vessels.

The fifth screen 530 of FIG. 5, as the second screen 430 of FIG. 4, shows an example of maritime navigation. In detail, the fifth screen 530 of FIG. 5 displays the gear status, engine RPM, and speed of the own vessel, and a path that the own vessel is following and the identified target vessels located in front of the own vessel may be displayed in the form of icons. In the fifth screen 530 of FIG. 5, one target vessel located within the overtaking space 511 is highlighted and displayed, allowing the user to identify that one target vessel is located close to the front of the own vessel.

The sixth screen 550 of FIG. 5 shows an example of a front image of the own vessel collected from a camera mounted on the bow of the own vessel. The sixth screen 550 of FIG. 5 is similar to the third screen 450 of FIG. 4 in that a bridge and two target vessels in front of the own vessel are illustrated, however, may be different in that one target vessel, which is located within the own vessel's overtaking space 511 and is determined to have a probability of collision, is highlighted and displayed using a technique such as augmented reality (AR). In particular, a gauge bar 551 that intuitively indicates the speeds of the own vessel and the target vessel, and the difference in heading angle/azimuth angle of the own vessel and the target vessel may be additionally displayed on the sixth screen 550 of FIG. 5.

FIG. 3 is described again.

When the probability of collision determining unit 231 determines that there is a probability of collision, the target vessel speed determining unit 233 may control the own vessel to perform an avoidance maneuver based on the criteria.

In an embodiment, when it is determined that there is the probability of collision, the target vessel speed determining unit 233 may control the own vessel to perform an avoidance maneuver based on the criteria, wherein the criteria may be a condition for the lowest speed among the speeds of at least one identified target vessel.

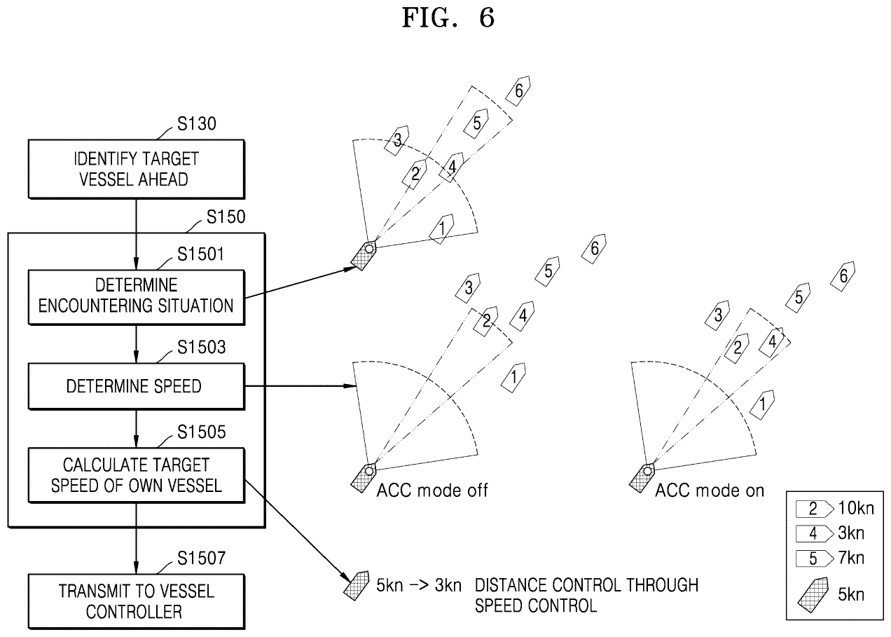

FIG. 6 is a diagram for describing a target vessel having a lowest speed, which is criteria for determining an avoidance maneuver of an own vessel, according to the present disclosure.

First, as described with reference to FIG. 1, the own vessel may identify at least one target vessel ahead (S130). When at least one target vessel is identified in front of the own vessel, the probability of collision determining unit 231 may determine a probability of collision, and when there is the probability of collision, a process of performing an avoidance maneuver may be entered (S150).

In detail, the probability of collision determining unit 231 may determine a situation of an encounter between the own vessel and the target vessel (S1501). The probability of collision determining unit 231 may determine that there is a probability of collision when it is determined that the target vessel is located within the own vessel's overtaking space and is thus in an overtaking situation, based on a difference in heading angle and azimuth between the own vessel and the target vessel ahead identified in operation S130, and then the target vessel speed determining unit 233 may determine the speed of the identified target vessel (S1503). When a plurality of target vessels ahead are identified, the target vessel speed determining unit 233 may determine the speed of all of the target vessels, detect one target vessel with a slowest speed (lowest speed) among them, and determine an estimated value of the speed of that target vessel.

For example, in FIG. 6, when only a target vessel number 2 navigating at 10 knots enters the overtaking space of the own vessel while the speed of the own vessel is 5 knots, the target vessel speed determining unit 233 may maintain the speed of the own vessel as it is and does not activate the adaptive speed control (ACC: Adaptive cruise control) mode according to the present disclosure, because the speed of the target vessel number 2 navigating in the overtaking space (10 knots) is faster than the current speed of the own vessel (5 knots).

As another example, in FIG. 6, when the speed of the own vessel is 5 knots and the target vessel number 2 navigating at 10 knots and a target vessel number 4 navigating at 3 knots enter the overtaking space of the own vessel, as the speed of the target vessel number 2 (10 knots) is faster than the current speed of the own vessel (5 knots) and the speed of the target vessel number 4 (3 knots) is slower than the current speed of the own vessel (5 knots), the target vessel speed determining unit 233 may detect the target vessel number 4 navigating at the optimal speed of 3 knots and estimate the speed of the fourth target vessel as 3 knots, and use that value to calculate a target speed of the own vessel. That is, the target vessel speed determining unit 233 may activate the adaptive speed control (ACC) mode according to the present disclosure.

Next, the own vessel speed calculating unit 235 may calculate the target speed based on a determination result of the target vessel speed determining unit 233 (S1505), and transmit the target speed to a main controller of the own vessel to change the own vessel's current speed (5 knots) to the target speed (3 knots) to perform an avoidance maneuver (S1507). In operation S1507, the own vessel speed calculating unit 235 may consider a preset margin in the process of calculating the own vessel's target speed. For example, the own vessel speed calculating unit 235 may calculate the target speed as a value obtained by subtracting a preset margin value of 0.5 from the lowest speed of the target vessel. In this case, the target speed of the own vessel may be calculated as 2.5 knots, and the speed of the own vessel may be adjusted from 5 knots to 2.5 knots. When the probability of collision with the target vessels ahead is eliminated after the avoidance maneuver of the own vessel, the own vessel speed calculating unit 235 may control the speed of the own vessel to return to that before identifying the target vessel determined to have the probability of collision, during an adaptive speed control process.

Ultimately, when it is determined that there is a probability of collision in a narrow area such as a narrow channel while the own vessel is autonomously navigating, the adaptive speed control apparatus 200 according to the present disclosure may control the own vessel to sequentially perform processes according to the present disclosure. In particular, in narrow channels, even when an overtaking situation occurs, overtaking is practically difficult because the path change of the own vessel is limited, and due to various environmental disturbances, it is difficult to implement a control process for continuously maintaining a constant distance from a moving object ahead when moving at sea, unlike when moving on land. However, according to the present disclosure, even when an overtaking situation occurs in narrow channels, it is possible to safely navigate while maintaining a preset path (path) without a collision.

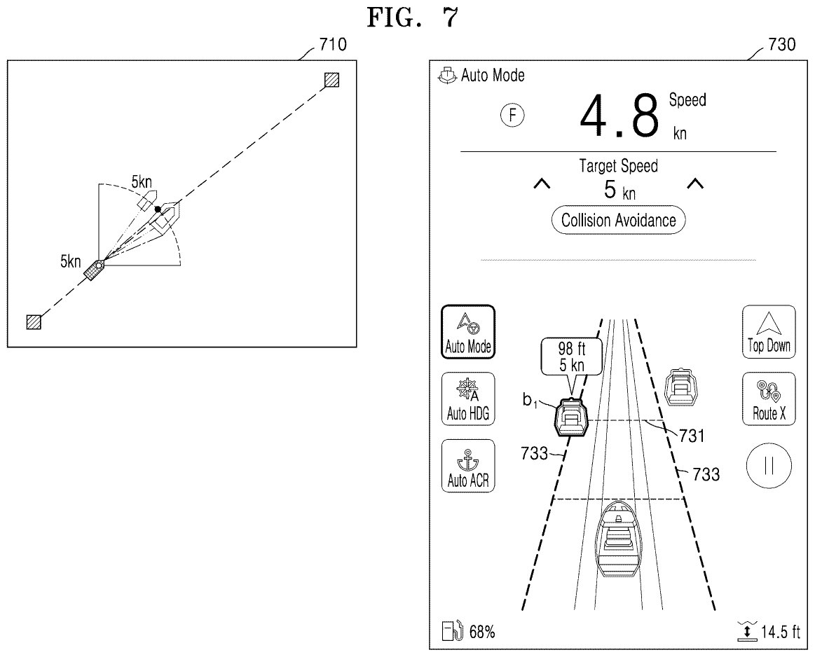

FIGS. 7 to 12 are diagrams for describing an adaptive speed control method according to the present disclosure, by using visualized information.

In detail, FIGS. 7 to 12 each consist of a mini-map screen and a navigation screen. The mini-map screen is a drawing to explain the relative distance and arrangement of an own vessel and target vessels, and the navigation screen is a drawing to explain the visual elements output from a navigation device and displayed on the display device installed on the own vessel or a user terminal. Hereinafter, the mini-map screen and the navigation screen are described to be output together on the display device or the user terminal, but the present disclosure is not limited thereto, and according to an embodiment, the mini-map screen may be omitted and only the navigation screen may be output on the display device or the user terminal.

First, FIG. 7 includes a first mini-map screen 710 and a first navigation screen 730. The first mini-map screen 710 shows an example of state in which a target vessel b₁, which is on the left front of the own vessel, has entered within a horizontal safety distance 731 set on path of the own vessel. Referring to the first navigation screen 730, it may be seen that, when the target vessel b₁ on the left front comes into contact with the horizontal safety distance 731 set by the user, a highlight is applied to the target vessel b₁ on the left front, and the size and estimated speed of the target vessel b₁ on the left front are displayed together. Additionally, even when another target vessel approaches within a vertical safety distance 733, a result similar to the first navigation screen 730 of FIG. 7 may be output.

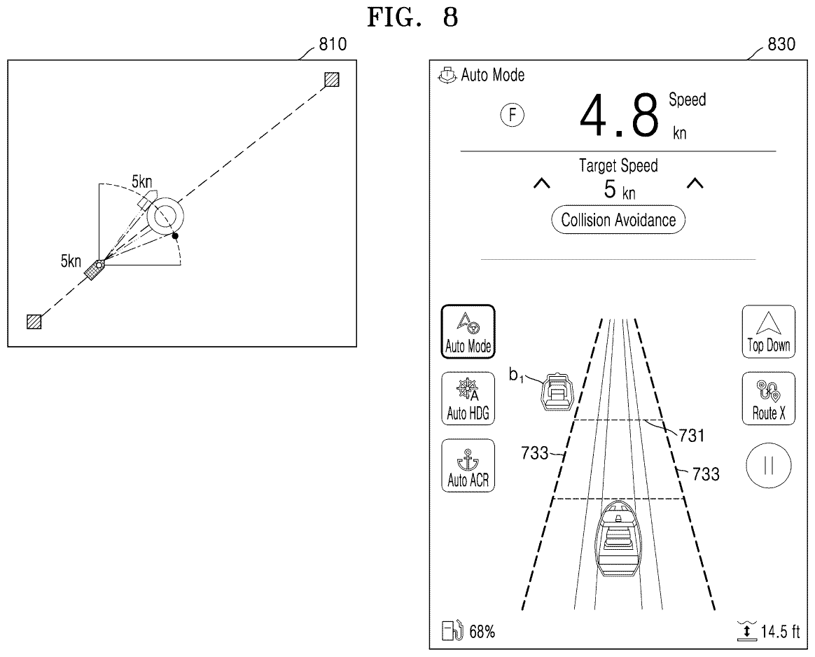

FIG. 8 includes a second mini-map screen 810 and a second navigation screen 830. The second mini-map screen 810 shows an example of a state in which the target vessel b₁ on the left front of the own vessel is outside the horizontal safety distance 731. In addition, referring to the second navigation screen 830, it may be seen that, when the target vessel b₁ on the left front of the own vessel deviates from the horizontal safety distance 731, the highlight applied to the target vessel b₁ on the left front is cleared, and the size and estimated speed of the target vessel b₁ on the left front, which were displayed together are also removed.

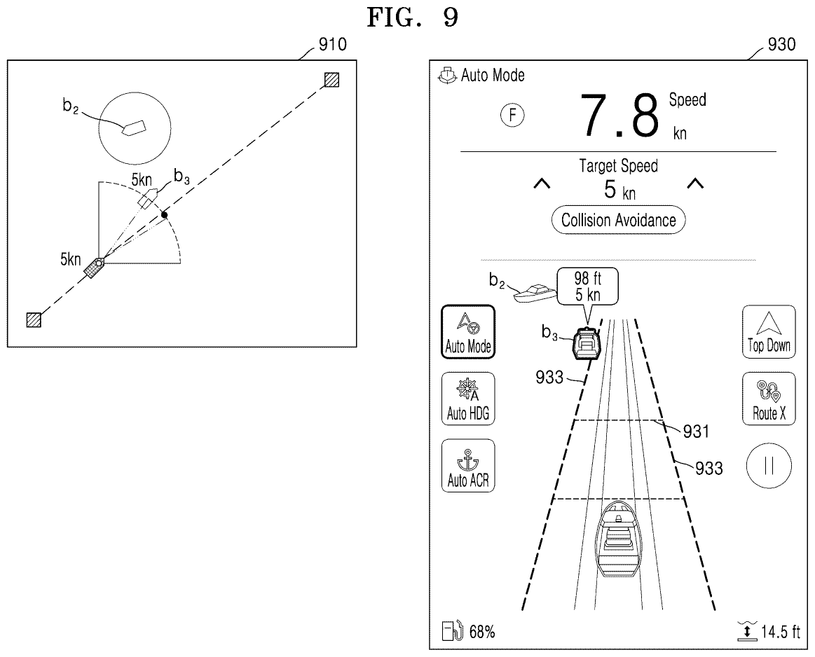

FIG. 9 includes a third mini-map screen 910 and a third navigation screen 930. The third mini-map screen 910 shows an example of a state in which a target vessel b₂, which is on the left front and is navigating in the opposite direction to the direction of travel of the own vessel, and a target vessel b₃, which is on the left front and is navigating in the same direction as the direction of travel of the vessel, have entered within a vertical safety distance 933 set on the path of the own vessel. Referring to the third navigation screen 930, it may be seen that, when the target vessel b₃ on the left front comes into contact with the vertical safety distance 933 set by the user, a highlight is applied to the target vessel b₃ on the left front, and the size and estimated speed of the target vessel b₃ on the left front are displayed together.

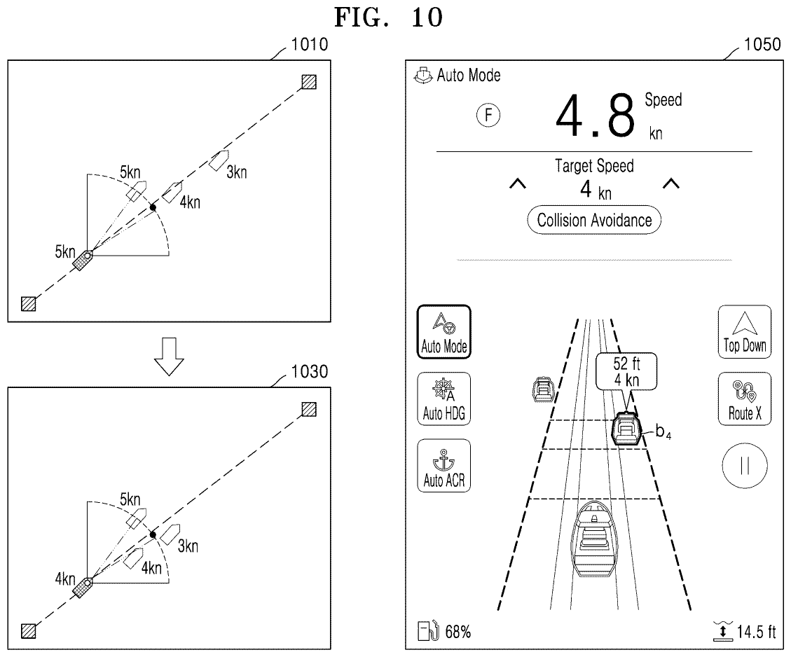

FIG. 10 includes a fourth mini-map screen 1010, a fifth mini-map screen 1030, and a fourth navigation screen 1050. The fourth mini-map screen 1010 shows three target vessels navigating in the same direction as the direction of travel of the own vessel in front of the own vessel. The fifth mini-map screen 1030 is a mini-map screen after a certain period of time has passed from the fourth mini-map screen 1010, and shows, as an example, that, among the three target vessels navigating in the same direction as the own vessel, those target vessels navigating at a slower speed (3 knots and 4 knots) than the own vessel have become closer to the own vessel. In addition, referring to the fourth navigation screen 1050, when a target vessel b₄ on the right front comes into contact with a horizontal safety distance 1051 set by the user, a highlight is applied to the target vessel b₄ on the right front, and as the target vessel b₄ on the right front encroaches on the path of the own vessel (the first path), a warning sign is visually applied to the path of the own vessel to notify of a risk of collision.

The user may quickly identify the risk of collision through the fourth navigation screen 1050 of FIG. 10, and the adaptive speed control apparatus 200 according to the present disclosure may reduce the speed of the own vessel from the current 4.8 knots to less than 4 knots, which is the speed of the target vessel b₄ on the right front.

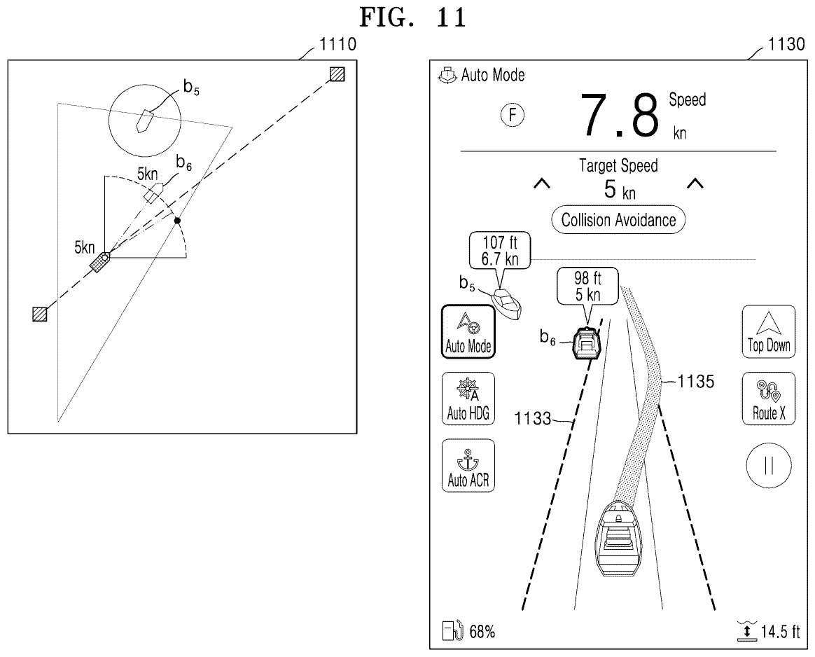

FIG. 11 includes a sixth mini-map screen 1110 and a fifth navigation screen 1130. The sixth mini-map screen 1110 shows an example of a state in which a target vessel b₅, which is on the left front and is navigating in the opposite direction to the direction of travel of the own vessel, and a target vessel b₆, which is on the left front and is navigating in the same direction as the direction of travel of the vessel, have entered within a vertical safety distance 1133 set on the path of the own vessel. In addition, the probability of collision determining unit 231 may determine that there is a probability of collision between the target vessel b₅ on the left front and the own vessel through a result of comparing the heading angle and the azimuth angle of the target vessel b₅ on the left front with the heading angle and the azimuth angle of the own vessel. When the probability of collision determining unit 231 determines that there is a probability of collision due to a target vessel moving in the opposite direction to the own vessel, the probability of collision determining unit 231 may control the display of an auxiliary triangle 1111 corresponding to the expected direction of travel of the target vessel b₅ on the left front, to be additionally displayed on the sixth mini-map screen 1110.

Here, when the direction of travel of the target vessel b₅ on the left front is opposite to the direction of travel of the own vessel, and after the probability of collision determining unit 231 determines that the target vessel b₅ on the left front has a probability of collision with the own vessel, the operation of the target vessel speed determining unit 233 for determining the lowest speed of the target vessel may be omitted, and the own vessel speed calculating unit 235 may immediately calculate a second path (avoidance path) for avoidance maneuver and calculate a target speed of the own vessel on the second path. Referring to FIG. 11, the own vessel speed calculating unit 235 may change the speed of the own vessel from the current speed of 5 knots to 7.8 knots and control the own vessel to sail on a second path 1135 different from the previous, first path.

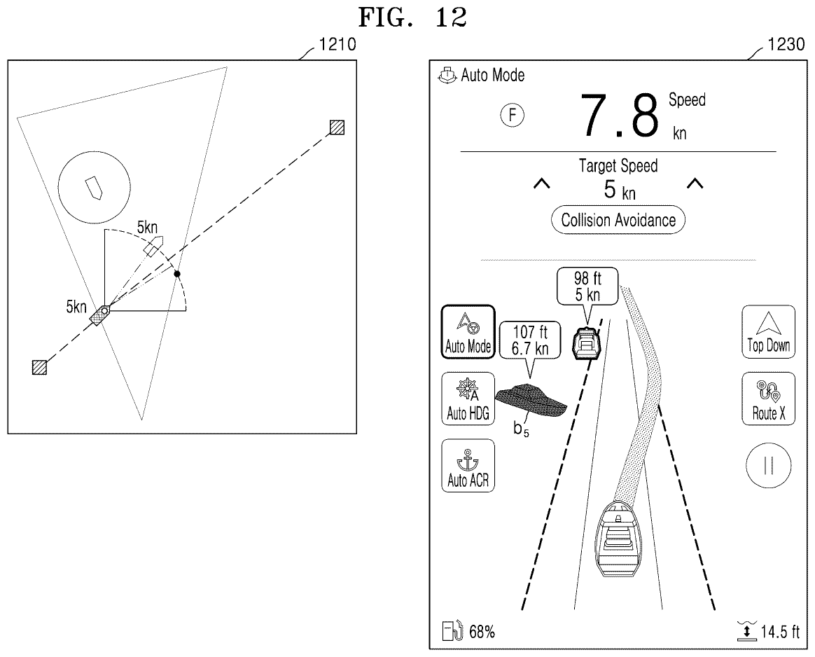

FIG. 12 includes a seventh mini-map screen 1210 and a sixth navigation screen 1230. The seventh mini-map screen 1210 illustrates an example in which a distance between the target vessel b₅ on the left front and the own vessel has become closer. In addition, referring to the sixth navigation screen 1230, it may be seen that, when an avoidance maneuver is not performed on the second path, a strong highlight mark is applied to the target vessel b₅ on the left front, which is expected to collide.

The processor 230 of the adaptive speed control apparatus 200 may process information necessary to output the mini-map screen and navigation screen described with reference to FIGS. 7 to 12 to the display device of the own vessel or the user terminal communicating with the adaptive speed control apparatus 200.

As an embodiment, the processor 230 may control the probability of collision determined by the probability of collision determining unit 231, to be output as visualized information by using a display device.

As an embodiment, the processor 230 may control the display device to highlight and display a target vessel with the lowest speed among the identified target vessels.

As an embodiment, the processor 230 may control the display device to additionally output a safety distance (horizontal direction, vertical direction) in addition to the preset first path on the display device, and may control the identified target vessels to be highlighted and displayed when those target vessels come into contact with the safety distance.

As an embodiment, the processor 230 may control the first path to be highlighted and displayed when there is a target vessel among the identified target vessels, which has come into contact with a safe distance (horizontal direction or vertical direction), as described above with reference to FIG. 10.

As an embodiment, when the processor 230 determines that there is a probability of collision and the direction of travel of the target vessel is opposite to the direction of travel of the own vessel, the processor 230 may generate the second path in addition to the preset first path and display the generated second path by using the display device. The present embodiment is schematically described with reference to FIGS. 11 and 12.

According to the present disclosure, collisions between vessels navigating in narrow channels may be prevented.

The embodiments according to the present disclosure may be implemented in the form of a computer program that may be executed through various components on a computer, and such a computer program may be recorded on a computer-readable medium. The medium may include magnetic media such as hard disks, floppy disks and magnetic tapes, optical recording media such as CD-ROMs and DVDs, magneto-optical media such as floptical disks, and hardware devices specifically configured to store and execute program instructions such as ROM, RAM, flash memory, etc.

Meanwhile, the computer program may be specially designed and configured for the present disclosure or may be well-known to and available to one of ordinary skill in the art of computer software. Examples of the computer program may include not only machine language code generated by using a compiler but also high-level language codes that can be executed by a computer by using an interpreter or the like.

The particular implementations shown and described herein are illustrative examples of the present disclosure and are not intended to otherwise limit the scope of the present disclosure in any way. For the sake of brevity, conventional electronics, control systems, software development and other functional aspects of the systems may not be described in detail. Furthermore, the connecting lines, or connectors shown in the various figures presented are intended to represent exemplary functional relationvessels and/or physical or logical couplings between the various elements. It should be noted that many alternative or additional functional relationvessels, physical connections or logical connections may be present in a practical device. Moreover, no item or component is essential to the practice of the present disclosure unless the element is specifically described as “essential” or “critical”.

The use of the terms “a” and “an” and “the” and similar referents in the context of describing the present disclosure (especially in the claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The present disclosure is not limited to the order in which the above steps are described. The use of any and all examples, or exemplary language (e.g., “such as”) provided herein, is intended merely to better illuminate the present disclosure and does not pose a limitation on the scope of the present disclosure unless otherwise claimed. Additionally, numerous modifications and adaptations will be readily apparent to those skilled in this art without departing from the spirit and scope of the present disclosure.

### Industrial Applicability

An embodiment of the present invention can be used in the industry for manufacturing leisure boats.

1. An adaptive vessel speed control method comprising:
identifying at least one target vessel in front of an own vessel while navigating on a first path;
determining a probability of collision with the at least one target vessel identified;
when it is determined that there is the probability of collision, controlling the own vessel to perform an avoidance maneuver based on criteria; and
after the avoidance maneuver is performed and the probability of collision is resolved, controlling a speed of the own vessel to return to that before identifying the target vessel determined to have the probability of collision.

2. The adaptive vessel speed control method of claim 1, wherein the controlling to perform the avoidance maneuver comprises controlling the own vessel to perform an avoidance maneuver when, in a state where the probability of collision is determined, the area in which the own vessel is currently navigating is determined to be a narrow channel with a width less than a preset width, based on a sensing value of a sensor of the own vessel.

3. The adaptive vessel speed control method of claim 1, wherein the at least one target vessel is in a preset overtaking section.

4. The adaptive vessel speed control method of claim 1, wherein the criteria comprise a condition for a lowest speed among speeds of the at least one target vessel.

5. The adaptive vessel speed control method of claim 1, wherein the controlling to perform the avoidance maneuver comprises detecting a target vessel within a first distance from the own vessel and then searching for a target vessel with a lowest speed among speeds of the at least one target vessel.

6. The adaptive vessel speed control method of claim 5, wherein the controlling to perform the avoidance maneuver comprises controlling the speed of the own vessel to be reduced to the lowest speed.

7. The adaptive vessel speed control method of claim 5, wherein the controlling to perform the avoidance maneuver comprises, when the lowest speed among the speeds of the target vessels is faster than a current speed of the own vessel, controlling to maintain the current speed of the own vessel.

8. The adaptive vessel speed control method of claim 1, wherein the determining of the probability of collision comprises controlling the determined probability of collision to be output as visualized information by using a display device.

9. The adaptive vessel speed control method of claim 8, wherein the determining of the probability of collision comprises controlling a target vessel with a lowest speed among the identified target vessels to be highlighted and displayed using the display device.

10. The adaptive vessel speed control method of claim 8, wherein the determining of the probability of collision comprises controlling to output a safety distance in addition to the first path on the display device, and controlling to highlight and display a target vessel that has come into contact with the safety distance among the identified target vessels.

11. The adaptive vessel speed control method of claim 10, wherein the determining of the probability of collision comprises, when there is a target vessel among the identified target vessels, which has come into contact with the safety distance, controlling the first path to be highlighted and displayed.

12. The adaptive vessel speed control method of claim 1, wherein the performing of the avoidance maneuver comprises, when it is determined that there is the probability of collision and a direction of travel of the target vessel is opposite to a direction of travel of the own vessel, generating a second path in addition to the first path, and displaying the generated second path by using a display device.

13. The adaptive vessel speed control method of claim 1, wherein the performing of the avoidance maneuver comprises, when it is determined that there is the probability of collision and a direction of travel of the target vessel is opposite to a direction of travel of the own vessel, controlling an auxiliary triangle corresponding to the direction of travel of the target vessel such that the auxiliary triangle is highlighted and displayed on a mini-map displayed on a vessel or a user terminal.

14. A computer-readable recording medium having stored thereon a program for executing the method according to claim 1.

15. An adaptive vessel speed control apparatus comprising:
a memory storing at least one program; and
a processor configured to perform an operation by executing the at least one program,
wherein the processor is further configured to identify at least one of target vessels and obstacles in front of an own vessel during navigation on a first path,
determine a probability of collision with at least one of the identified target vessels and obstacles,
when it is determined that there is the probability of collision, control the own vessel to perform an avoidance maneuver based on criteria, and
after the avoidance maneuver is performed and the probability of collision is resolved, control a speed of the own vessel to return to that before identifying a target vessel determined to have the probability of collision.
